(19) United States
(12) Patent Application Publication
(10) Pub. No.: US 2015/0101782 A1
(43) Pub. Date: Apr. 16, 2015

(54) EVAPORATIVE INTERCOOLER

(71) Applicant: Ford Global Technologies, LLC, Dearborn, MI (US)

(72) Inventor: Jean-Philippe Puetzer, Hellenthal (DE)

(21) Appl. No.: 14/514,842

(22) Filed: Oct. 15, 2014

(30) Foreign Application Priority Data
Oct. 16, 2013 (DE) 102013220923.1

(51) Int. Cl. F02B 29/04; F28D 15/00

(52) U.S. Cl. CPC F02B 29/0481; F28D 15/00
USPC 165/104.13

(57) ABSTRACT

The invention concerns an intercooler (1) which has a through-flow element (2), through which charge air to be cooled flows from an input side (3) towards an output side (4).

It is proposed that the through-flow element (2) is arranged in the housing (6) in which at least one atomizer nozzle (7) is arranged, which atomizes a coolant within the housing (6). wherein a closed circuit (19) having a vacuum pump (9) is arranged on the housing (6).

### RELATED APPLICATIONS

The present application claims priority to German Patent Application No. 102013220923.1, filed Oct. 16, 2013, the entire contents of which are hereby incorporated by reference for all purposes.

### TECHNICAL FIELD

The present invention concerns an intercooler which has a through-flow element through which charge air to be cooled flows from an input side towards an output side.

### BACKGROUND OF THE INVENTION

An intercooler is a heat exchanger which, in the exhaust tract of a charged internal combustion engine, reduces the temperature of the combustion air supplied to the engine. The intercooler dissipates part of the heat which results from compression of the air in the turbocharger.

The aim is to increase the performance and efficiency of the engine. By reducing the temperature of the supply air, a greater air mass is obtained in the same volume. Therefore proportionally more fuel can be burned: the intercooler thus increases the possible output power.

intercoolers are used not only on powerful engines and for racing use, but also in downsizing of engines, since in smaller engines, charge-air cooling allows more power and reduced fuel consumption. In particular in diesel engines, intercoolers are practically essential since today's emission values could not be achieved with normally aspirated engines and above all with charged engines (without cooling).

Intercoolers therefore cool the charge air of a combustion engine and hence reduce the thermal load on the engine, whereby also the nitrous oxide load on the environment is reduced. Intercoolers have previously been designed as air/air intercoolers, whereby air passing over the through-flow element causes a cooling of the charge aft. To guarantee that sufficient air can be diverted past the through-flow element, it is sensible to mount the intercooler, i.e. its through-flow element, at the front of the vehicle, as close as possible to an air intake. This means however that the intercooler requires a cooling surface at the vehicle front. The cooling area available at the vehicle front is however greatly limited. Also great complexity is required to guide the charge air via pipes to the through-flow element and once cooled. from there to the inlet side of the internal combustion engine. These additional pipes again require a great amount of the very limited assembly space available within the engine bay. Also, air/air intercoolers cannot maintain a constant charge air temperature, wherein air/air intercoolers are not very effective.

However fluid intercoolers are also known, i.e. water intercoolers, wherein the through-flow element is surrounded by a fluid jacket. A fluid circulates in the fluid jacket. DE 10 2006 008 826 B4 for example describes that the intercooler can be connected firstly to a coolant circuit of the internal combustion engine in order to heat the charge air when necessary. Secondly, the intercooler can have a separate coolant circuit to cool the charge air. The separate coolant circuit however has no contact with the internal combustion engine and in particular no contact with the coolant circuit of the internal combustion engine.

The design of an intercooler offers room for improvement, with regard to its double function in relation to cooling the charge air and to heating the charge air supplied to the engine.

### SUMMARY OF THE INVENTION

In this context, the present invention is based on the object of providing an intercooler which is simplified and improved in relation to the present state of the art, and also more effective.

This object is achieved by an intercooler with the features of claim 1. Further particularly advantageous embodiments of the invention are disclosed in the subclaims.

It is pointed out that the features listed individually in the description below can be combined in any technically sensible manner and indicate further embodiments of the invention. The description characterizes and specifies the invention further, in particular in connection with the figures.

According to the invention, an intercooler has a through-flow element through which charge air to be cooled flows from an input side towards an output side. Advantageously the through-flow element is arranged in a housing in which at least one atomizer nozzle is arranged, which atomizes a coolant within the housing, wherein a dosed circuit having a vacuum pump is arranged on the housing.

The charge air is supplied to the through-flow element and flows through this. The through-flow element is arranged in the housing, wherein the housing is pressure-tight. To this extent, the through-flow element is dosed against the environment. The coolant is introduced inside the housing by means of the at least one atomizer nozzle, such that a virtual fluid mist results. So the through-flow element is surrounded by a fluid mist, wherein the small droplets of the fluid mist evaporate under the effect of corresponding heat, which is also the case if the mist droplets have contact with the wall of the through-flow element. This ensures effective cooling of the charge air flowing through the through-flow element.

It is useful in the sense of the invention if a vacuum is generated within the housing. The vacuum reduces the boiling point of the coolant, which is preferably water, in relation to the boiling point at normal pressure (1013.25 hPa). In order to generate the vacuum within the housing, a vacuum pump is provided which is connected to the interior of the housing via a connection element.

It is favorable if the vacuum pump is arranged in the circuit which comprises a condenser, an accumulator and/or equalizing tank, and a feed pump.

By means of the vacuum pump, the vacuum in the housing is maintained while at the same time water vapor is transported out of the housing. A condenser is arranged downstream of the vacuum pump, in which the water vapor condenses. From the condenser, the condensed water is conducted to the accumulator and/or equalizing tank which is connected to the feed pump. The feed pump delivers the condensed water to the at least one atomizer nozzle which is arranged inside the housing.

The housing in which the through-flow element is arranged has a connection element to the vacuum pump, wherein also a connection line is provided to the at least one atomizer nozzle. The at least one connection line leads from the accumulator and/or equalizing tank to the at least one atomizer nozzle, wherein the water pump is arranged between the accumulator and/or equalizing tank and the at least one atomizer nozzle.

The housing is preferably a pressure-tight housing. The individual components are connected together via lines.

It is suitable in the sense of the invention if several atomizer nozzles are arranged inside the housing. The connection line should only have branches and/or take-offs, leading to the respective atomizer nozzles, downstream of the water pump. In the preferred embodiment, as an example four atomizer nozzles are provided, wherein this number is naturally not restrictive. In each case two of the exemplary four atomizer nozzles are arranged in pairs opposite each other viewed in cross section.

It is suitable if a closed circuit is formed, wherein within the housing atomized coolant, i.e. atomized water, causes a cooling of the through-flow element and hence of the charge air. After extraction, the water vapor is supplied to the condenser and after removal from the accumulator and/or equalizing tank, returned to the at least one atomizer nozzle by means of the feed pump, i.e. the water pump. The water vapor is easily extracted because of the vacuum generated by the vacuum pump. Thus the water vapor is supplied to the condenser through the connection element, passing the vacuum pump.

The invention therefore achieves a very effective cooling of the charge air in that small mist droplets evaporate within the housing. This is therefore known as evaporative coding. Also a very compact construction is proposed, wherein the intercooler with its components can be mounted freely without the need for a direct air flow for cooling at the vehicle front. Rather the intercooler can be arranged at previously unused locations, whereby even an arrangement very close to the internal combustion engine is possible, to achieve shorter intake tracts and hence a better response behavior. To this extent, the intercooler according to the invention can reduce air resistance since the intercooler need no longer be arranged at the vehicle front region, and the cooling area there is not disadvantageously increased. It is furthermore advantageous that the intercooler can keep the charge air temperature constantly at a specific temperature level due to the independence from a cooling air flow of varying intensity, so that a more constant performance of the internal combustion engine can be achieved.

With the intercooler according to the invention, the charge air can be kept constantly at a desired temperature level, i.e. cooled. If the internal combustion engine is e.g. in a warm-up phase so that cooling of the charge air is not necessary, the supply of coolant to the atomizer nozzles can be interrupted. This is possible for example by a corresponding control of the water pump, by switching this to be inactive. It is also possible to arrange control elements e.g. valves, which can also be fully switchable, in the connecting line in order to reduce or completely suppress the supply of coolant to the atomizer nozzles. If the charge air is not cooled, an improved warm-up behavior of the internal combustion engine is achieved so that its warm-up phase can even be shortened since quasi-warmed air is being supplied.

The above advantages and other advantages and features will be readily apparent from the following detailed description of the preferred embodiments when taken in connection with the accompanying drawings.

### BRIEF DESCRIPTION OF THE DRAWINGS

Further features and advantages of the invention arise from the following description of a non-restrictive exemplary embodiment of the invention, which is explained in more detail below with reference to the drawing. The drawing shows:

FIG. 1 a principle sketch of an intercooler with connected coolant circuit.

### DETAILED DESCRIPTION OF THE PREFERRED EMBODIMENTS

In the attached figure the same reference numerals will be used to refer to the same components. In the following description various operating parameters and components are described for different constructed embodiments. These specific parameters and components are included as examples and are not meant to be limiting.

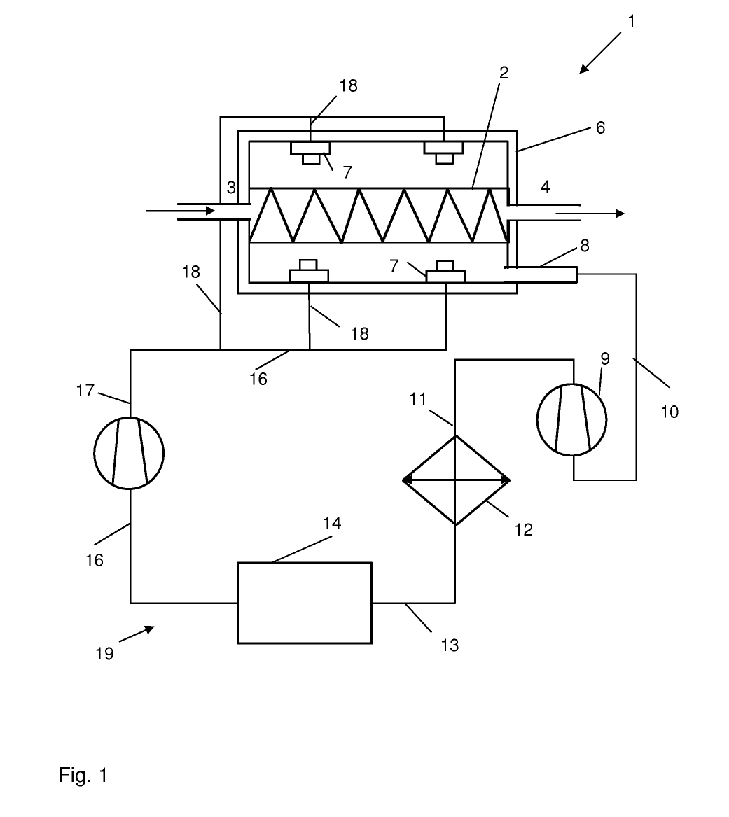

FIG. 1 shows an intercooler 1 which has a through-flow element 2, through which the charge air to be cooled flows from an input side 3 towards an output side 4. The flow direction is evident by the arrows. The through-flow element 2 is arranged in a housing 6 in which at least one atomizer nozzle 7 is arranged, which atomizes a coolant within the housing 6.

As evident in FIG. 1 several—for example four—atomizer nozzles 7 are arranged in the housing 6. In each case two of the exemplary four atomizer nozzles 7 are arranged in pairs opposite each other, viewed in cross section, in the housing 6.

The housing 6 has a connection element 8 to which a vacuum pump 9 is connected. The connection element 8 is arranged on the housing 6, for example on the output side 4 of the through-flow element 2. In a preferred embodiment, the connection element 8 is arranged on a face of the housing 6 in a bottom region in the drawing plane. It is also possible to arrange the connection element 8 in a lower region on the long side of the housing 6.

As already stated, the vacuum pump 9 is connected to the connection element 8 via a suction line 10. The vacuum pump 9 is connected via a line 11 to a condenser 12, which in turn is connected via a connecting line 13 to an accumulator and/or equalizing tank 14. A connection line 16, in which a water pump 17 is arranged, is connected to the accumulator and equalizing tank 14, wherein the connection line 16 has take-offs and/or branches 18 to the atomizer nozzles 7.

The components listed above form a closed circuit 19. The water pump 17 delivers coolant to the at least one atomizer nozzle 7, or to the four atomizer nozzles 7 shown as an example. These atomize the coolant on its emergence from the atomizer nozzles 7, so that a fluid mist with mist droplets is produced within the housing. The mist droplets come into contact with the through-flow element 2, through which the air flow to be cooled flows. Naturally the through-flow element 2, i.e. its wall, is heated, wherein the mist droplets evaporate on contact with the through-flow element 2, i.e. its wall. In relation to the ambient pressure, a vacuum is generated within the housing 6 by means of the vacuum pump 9, so that the boiling temperature i.e. the boiling point of the coolant, which is preferably water, is reduced. The vacuum pump 9 advantageously has a second function. The vacuum pump 9 not only reduces the pressure in the housing 6 but also extracts the resulting water vapor, so that this is conducted past the vacuum pump 9 to the condenser 12. Here the water vapor is condensed and conducted in liquid form to the accumulator and/or equalizing tank. Thus a closed circuit 19 is created, in which coolant is conducted to the atomizer nozzle 7 by means of the water pump 17, wherein the resulting water vapor is extracted by means of the vacuum pump.

It is therefore useful to arrange the connection element 8 in a lower region of the housing 6, since any coolant precipitated there can thus be removed easily, which can be achieved via the suction effect of the vacuum pump 9. It is conceivable to arrange the housing 6 slightly inclined so that the connection point to the connection element 8 forms the lowest part of the housing 6, and any precipitated coolant can flow under gravity towards the connection element 8.

One skilled in the art will readily recognize from such discussion, and from the accompanying drawings and claims that various changes, modifications and variations can be made therein without departing from the true spirit and fair scope of the invention as defined by the following claims.

### List of Reference Numerals

1 Intercooler
2 Through-flow element
3 Input side of 2
4 Output side of 2
5
6 Housing
7 Atomizer nozzle
8 Connection element
9 Vacuum pump
10 Line
11 Line
12 Condenser
13 Connection line
14 Accumulator and/or equalizing tank
15
16 Connection line
17 Water pump
18 Take-offs and/or branches
19 Circuit

1. An intercooler which has a through-flow element (2) through which charge air to be cooled flows from an input side (3) towards an output side (4), wherein the through-flow element (2) is arranged in a housing (6) in which at least one atomizer nozzle (7) is arranged, which atomizes a coolant within the housing (6), wherein a closed circuit (19) having a vacuum pump (9) is arranged in relation to en the housing (6).

2. The intercooler as claimed in claim 1, wherein the vacuum pump (9) is connected to the housing (6).

3. The intercooler as claimed in claim 1, wherein the circuit (19) comprises a vacuum pump (9), a condenser (12), an accumulator and/or equalizing tank (14), a water pump (17) and the at least one atomizer nozzle (7).

4. The intercooler as claimed in claim 1, wherein several atomizer nozzles (7) are arranged in the housing (6).

5. The intercooler as claimed in claim 1, wherein the housing (6) is designed as a pressure-tight housing (6).

6. The intercooler as claimed in claim 2, wherein the circuit (19) comprises a vacuum pump (9), a condenser (12), an accumulator and/or equalizing tank (14), a water pump (17) and the at least one atomizer nozzle (7).

7. The intercooler as claimed in claim 2, wherein several atomizer nozzles (7) are arranged in the housing (6).

8. The intercooler as claimed in claim 3, wherein several atomizer nozzles (7) are arranged in the housing (6).

9. The intercooler as claimed in claim 2, wherein the housing (6) is designed as a pressure-tight housing (6).

10. The intercooler as claimed in claim 3, wherein the housing (6) is designed as a pressure-tight housing (6).

11. The intercooler as claimed in claim 4, wherein the housing (6) is designed as a pressure-tight housing (6).

12. An intercooler for a vehicle comprising:
a housing (6);
a flow through element (2) disposed within said housing (6), said element (2) having an input side (3) and an output side (4);
an atomizer nozzle (7) disposed within said housing (6);
a closed circuit (19) having a vacuum pump (9) in operative association with said housing.

13. The intercooler as claimed in claim 12, wherein the vacuum pump (9) is connected to the housing (6).

14. The intercooler as claimed in claim 12, wherein the circuit (19) comprises a vacuum pump (9), a condenser (12), an accumulator and/or equalizing tank (14), a water pump (17) and the at least one atomizer nozzle (7).

15. The intercooler as claimed in claim 12. wherein several atomizer nozzles (7) are arranged in the housing (6).

16. The intercooler as claimed in claim 12, wherein the housing (6) is designed as a pressure-tight housing (6).

17. A method for reducing the temperature of air being supplied to an internal combustion engine comprising the steps of:
forming an intercooler comprising a housing (6) a flow through element (2) disposed within said housing (6), said element (2) having an input side (3) and an output side (4), an atomizer nozzle (7) disposed within said housing (6), and a closed circuit (19) having a vacuum pump (9) in operative association with said housing;
passing air from said input side (3) to said output side (4); and
atomizing a coolant with said nozzle (7) within said housing whereby said passing air is cooled as it passes through said element (2).

18. The method for the reducing temperature of air being supplied to an internal combustion engine as claimed in claim 12, wherein the vacuum pump (9) is connected to the housing (6).

19. The method for the reducing temperature of air being supplied to an internal combustion engine as claimed in claim 12, wherein the circuit (19) comprises a vacuum pump (9), a condenser (12), an accumulator and/or equalizing tank (14), a water pump (17) and the at least one atomizer nozzle (7).

20. The method for the reducing temperature of air being supplied to an internal combustion engine as claimed in claim 12, wherein several atomizer nozzles (7) are arranged in the housing (6).
